(19) United States
(12) Patent Application Publication
(10) Pub. No.: US 2026/0066488 A1
(43) Pub. Date: Mar. 5, 2026

(54) ELECTRODE ASSEMBLY AND SECONDARY BATTERY INCLUDING THE SAME

(71) Applicant: SK ON CO., LTD., Seoul (KR)

(72) Inventors: Yong Seok LEE, Daejeon (KR); Byung Mook KIM, Daejeon (KR); Hai Sol NAM, Daejeon (KR); Mi So RHO, Daejeon (KR); Kyung Tae PARK, Daejeon (KR); Byeong Hyeon PARK, Daejeon (KR); Jong Hun PARK, Daejeon (KR); Hye Ryeon LEE, Daejeon (KR); Yoo Jung HUR, Daejeon (KR)

(21) Appl. No.: 19/309,642

(22) Filed: Aug. 26, 2025

(30) Foreign Application Priority Data
Aug. 29, 2024 (KR) 10-2024-0117060
Aug. 18, 2025 (KR) 10-2025-0114272

(51) Int. Cl. H01M 50/533; H01M 10/0587; H01M 50/46

(52) U.S. Cl. CPC H01M 50/533; H01M 10/0587; H01M 50/46

(57) ABSTRACT

An electrode assembly according to embodiments of the present disclosure includes a separator and an electrode wound with the separator therebetween. The electrode includes an electrode current collector including a coated region and an uncoated region, and an active material layer formed on the coated region of the electrode current collector. The uncoated region includes a tab region including protrusions that extend in a direction perpendicular to the winding direction of the electrode and parallel to the coated region. The tab region includes protrusions having different widths.

### CROSS-REFERENCE TO RELATED APPLICATIONS

This application claims priority to Korean Patent Applications No. 10-2024-0117060 filed on Aug. 29, 2024 and No. 10-2025-0114272 filed on Aug. 18, 2025 in the Korean Intellectual Property Office (KIPO), the entire disclosure of which is incorporated by reference herein.

### BACKGROUND

### 1. Field of the Invention

The disclosure of the present application relates to an electrode assembly and a secondary battery including the same.

### 2. Description of the Related Art

Secondary batteries are batteries that can be repeatedly charged and discharged. With the development of information and communication and display industries, the secondary batteries have been widely applied as power sources for portable electronic communication devices, such as camcorders, mobile phones, and laptop PCs. In addition, battery packs including the secondary batteries have recently been developed and applied as power sources for eco-friendly vehicles, such as hybrid cars.

Examples of the secondary battery include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

The secondary battery includes an electrode current collector and an active material formed on the electrode current collector. Generally, the electrode current collector includes a tab that electrically connects the electrode current collector to the outside and acts as a passage for electron migration.

A tab-less battery is a battery in which the tab is removed, and a portion of the electrode current collector that does not include an active material may be connected to a current collector plate. In the tab-less battery, the entire surface of the current collector plate may be used as a conductor to transfer elections. By utilizing the entire surface as a conductor, internal resistance can be reduced and heat can be dispersed. Accordingly, research and development on the tab-less batteries have been actively conducted in recent years.

However, depending on the internal structure design of the tab-less battery, differences may arise in resistance properties, cycle life properties and the like. In addition, differences may occur in process efficiency for manufacturing the tab-less battery.

### SUMMARY

An object of the present disclosure is to provide an electrode assembly with improved electrical properties.

Another object of the present disclosure is to provide a secondary battery with improved electrical properties.

An electrode assembly according to the present disclosure includes: a separator, and an electrode that is wound with the separator therebetween, and includes an electrode current collector including a coated region and an uncoated region, and an active material layer formed on the coated region of the electrode current collector. The uncoated region includes a tab region including protrusions that extend in a direction perpendicular to the winding direction of the electrode and parallel to the coated region. The tab region includes a first tab region and a second tab region, which are adjacent to each other, and the protrusions include first protrusions included in the first tab region and second protrusions included in the second tab region. The first tab region is disposed closer to a winding start part of the electrode assembly than the second tab region, and a width of each of the first protrusions is greater than that of each of the second protrusions.

According to exemplary embodiments, the first tab region and the second tab region may be alternately repeated along the winding direction.

According to exemplary embodiments, a ratio of the width of each of the second protrusions to the width of each of the first protrusions may be 50% to 95%.

According to exemplary embodiments, the uncoated region may further include a third tab region including third protrusions having a width greater than that of each of the second protrusions, and the second tab region may be disposed between the first tab region and the third tab region.

According to exemplary embodiments, a ratio of the width of each of the second protrusions to the width of each of the third protrusions may be 50% to 95%.

According to exemplary embodiments, the uncoated region may further include a fourth tab region including fourth protrusions having a width smaller than that of each of the third protrusions, and the third tab region may be disposed between the second tab region and the fourth tab region.

According to exemplary embodiments, a ratio of the width of each of the fourth protrusions to the width of each of the third protrusions may be 50% to 95%.

According to exemplary embodiments, the uncoated region may further include a fifth tab region including fifth protrusions having a width greater than that of each of the fourth protrusions, and the fourth tab region may be disposed between the third tab region and the fifth tab region.

According to exemplary embodiments, a ratio of the width of each of the fourth protrusions to the width of each of the fifth protrusions may be 50% to 95%.

According to exemplary embodiments, the first tab region, the second tab region, the third tab region, the fourth tab region and the fifth tab region may be arranged sequentially from the winding start part.

According to exemplary embodiments, the uncoated region may be disposed between the coated region and the protrusions, and may further include a margin portion extending in the winding direction.

According to exemplary embodiments, the margin portion may include a first margin portion located at one end in the winding direction and a second margin portion located at the other end in the winding direction, and the tab region may be disposed between the first margin portion and the second margin portion.

According to exemplary embodiments, a ratio of the length of the first margin portion to the total length of the electrode assembly in the winding direction may be 11% to 17%.

According to exemplary embodiments, a ratio of the length of the first margin portion to the total length of the electrode assembly in the winding direction may be 12% to 15.5%.

According to exemplary embodiments, a ratio of the length of the second margin portion to the total length of the electrode assembly in the winding direction may be 11% to 20%.

According to exemplary embodiments, an L value, defined by Equation 1 below, may be 80 to 120:

L=[L_{B1}/(L_{B2}×D)]×100 [Equation 1]

In Equation 1, L_{B1} is the length in millimeter (mm) of the first margin portion, L_{B2} is the length in mm of the electrode assembly, and D is the thickness in mm of the electrode.

According to exemplary embodiments, a ratio of the height of the protrusions in the direction perpendicular to the winding direction and parallel to the coated region to the total length of the electrode assembly in the winding direction may be 0.05% to 0.20%.

A secondary battery according to the present disclosure includes: the above-described electrode assembly wound around a winding core; and a case configured to accommodate the electrode assembly.

According to exemplary embodiments, the electrode assembly may have a jelly roll structure in which it is repeatedly wound around the winding core.

The electrode assembly according to the present disclosure includes a coated region and an uncoated region, and the uncoated region includes protrusions that extend in a direction perpendicular to the winding direction of the electrode and parallel to the coated region, and the widths of the protrusions may be different from each other. Accordingly, the electrolyte impregnation properties may be improved. In addition, the resistance properties of a secondary battery including the electrode assembly may be improved.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an electrode assembly according to exemplary embodiments;

FIG. 2 is a schematic enlarged view illustrating a tab region of the electrode assembly according to exemplary embodiments;

FIGS. 3 to 5 are schematic enlarged views illustrating tab regions of the electrode assembly according to some embodiments;

FIG. 6 is a schematic perspective view illustrating a secondary battery including the electrode assembly according to exemplary embodiments; and

FIG. 7 is a schematic cross-sectional view illustrating the secondary battery according to exemplary embodiments.

### DETAILED DESCRIPTION OF THE INVENTION

The electrode assembly according to the embodiments of the present disclosure includes a separator, and an electrode wound with the separator therebetween. The electrode includes an electrode current collector including a coated region and an uncoated region, and an active material layer formed on the coated region of the electrode current collector. The uncoated region includes a tab region including protrusions that extend in a direction perpendicular to the winding direction of the electrode and parallel to the coated region, and the widths of the protrusions may be different.

The electrode assembly according to the present disclosure and the secondary battery including the same may be widely applied in green technology fields, such as electric vehicles, battery charging stations, as well as solar power generation, wind power generation, and the like, which use the batteries. The electrode assembly of the present disclosure and the secondary battery including the same may be used in eco-friendly electric vehicles, hybrid vehicles, and the like, which are aimed at mitigating climate change by reducing air pollution and greenhouse gas emissions.

As used herein, the terms “upper surface,” “lower surface,” “upper portion,” “lower portion,” “bottom surface,” “bottom portion,” and the like are used in a relative sense to distinguish the positions of components, and do not specify absolute positions.

As used herein, the term “thickness direction” may refer to a direction in which the cathode and the anode of the electrode assembly are stacked. The “width direction” may refer to a direction parallel to the upper or lower surface of the electrode assembly, and may indicate a direction in which the protrusions of the electrode assembly extend. The “winding direction” or “length direction” may refer to a direction parallel to the upper or lower surface of the electrode assembly and perpendicular to the width direction.

Hereinafter, embodiments of the present disclosure will be described in detail with reference to the drawings. However, the embodiments are merely illustrative, and the present disclosure is not limited to the specific embodiments described by way of example.

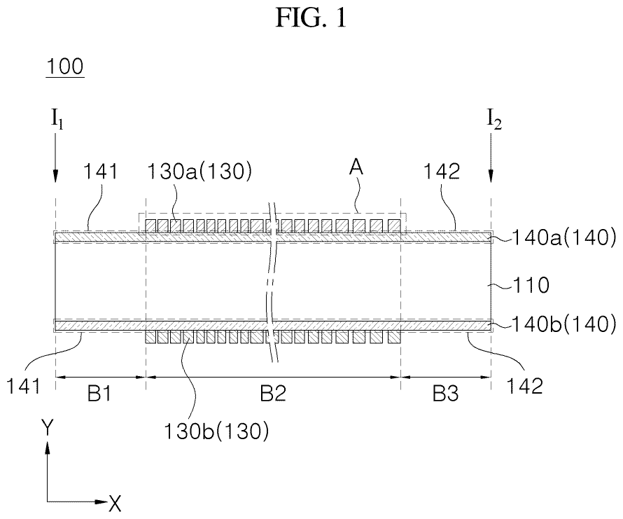

FIG. 1 is a schematic cross-sectional view illustrating an electrode assembly according to exemplary embodiments.

Referring to FIG. 1, an electrode assembly 100 may include a separator and an electrode wound with the separator interposed therebetween. The electrode may include an electrode current collector, and an active material layer formed on the coated region 110 of the electrode current collector. For example, the separator may be interposed between a cathode including a cathode current collector and an anode including an anode current collector.

The electrode current collector includes a coated region 110 and an uncoated region.

The uncoated region may include protrusions 130 and a margin portion 140. The uncoated region may include a tab region B2 including the protrusions 130. The uncoated region may include a first margin region B1 and a second margin region B3, and the tab region B2 may be disposed between the first margin region B1 and the second margin region B3.

In some embodiments, the separator may include a porous polymer film or a porous nonwoven fabric. The porous polymer film may include a polyolefin polymer such as an ethylene polymer, a propylene polymer, an ethylene/butene copolymer, an ethylenelhexene copolymer, or an ethylene/methacrylate copolymer.

The porous nonwoven fabric may include glass fibers having a high melting point, polyethylene terephthalate fibers and the like.

In some embodiments, the separator may also include a ceramic material. For example, inorganic particles may be coated on the polymer film or dispersed in the polymer film to improve heat resistance.

According to exemplary embodiments, an active material layer may be formed on the coated region 110 of the electrode current collector.

For example, a cathode active material layer may be formed on the coated region 110 of the cathode current collector.

For example, a cathode slurry may be prepared by mixing and stirring a cathode active material with a binder, a conductive material, and/or a dispersant in a solvent. The cathode slurry may be coated on the coated region 110 of the cathode current collector, and then dried and compressed to prepare a cathode including a cathode active material layer.

The cathode current collector may include stainless steel, nickel, aluminum, titanium, or an alloy thereof. The cathode current collector may also include aluminum or stainless steel whose surface has been treated with carbon, nickel, titanium, or silver.

The cathode active material may include a compound capable of reversibly intercalating and deintercalating lithium ions. In this case, the secondary battery including the electrode assembly 100 may be provided as a lithium secondary battery.

According to exemplary embodiments, the cathode active material may include lithium metal oxide particles. For example, the lithium metal oxide particles may include nickel (Ni), and may further include at least one of cobalt (Co), manganese (Mn) and aluminum (Al).

In some embodiments, the lithium metal oxide particles may include lithium-nickel-cobalt-manganese (LNCM)-based oxide, lithium-nickel-manganese (LNM)-based oxide, lithium-nickel-aluminum (LNA)-based oxide and the like.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for the cathode. In this case, the amount of binder for forming the cathode active material layer 110 may be reduced, and the amount of cathode active material or lithium metal oxide particles may be relatively increased, thereby improving the output and capacity of the battery cell.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, or LaSrMnO₃, etc.

For example, an anode active material layer may be formed on the coated region 110 of the anode current collector.

For example, an anode slurry may be prepared by mixing and stirring an anode active material with a binder, a conductive material, and/or a dispersant in a solvent. The anode slurry may be coated on the coated region 110 of the anode current collector, and then dried and compressed to prepare an anode including an anode active material layer.

Non-limiting examples of the anode current collector may include a copper foil, a nickel foil, a stainless steel foil, a titanium foil, a nickel foam, a copper foam, a polymer substrate coated with conductive metal and the like.

As the anode active material, any active material known in the art may be used, so long as it is capable of intercalating and deintercalating lithium ions. For example, carbon-based materials such as crystalline carbon, amorphous carbon, carbon composites, carbon fibers, etc., a lithium alloy, or a silicon (Si)-based active material may be used.

Examples of the amorphous carbon may include hard carbon, cokes, mesocarbon microbeads (MCMB), mesophase pitch-based carbon fibers (MPCF) or the like. Examples of the crystalline carbon may include graphite-based carbon such as natural graphite, artificial graphite, graphite cokes, graphite MCMB, graphite MPCF or the like.

Elements contained in the lithium alloy may include aluminum, zinc, bismuth, cadmium, antimony, silicon, lead, tin, gallium, indium, etc.

The silicon-based active material may provide further increased capacity properties. The silicon-based active material may include Si, SiOₓ (0<x<2), metal-doped SiOₓ (0<x<2), a silicon-carbon composite, etc. The metal may include lithium and/or magnesium, and the metal-doped SiOₓ (0<x<2) may include a metal silicate.

As the binder and conductive material, materials which are substantially the same as or similar to the above-described materials used in the cathode active material layer may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

According to exemplary embodiments, the uncoated region may include the protrusions 130 and the margin portion 140. For example, a portion of the uncoated region of the electrode current collector may be cut and/or segmented to form the protrusions 130 and the margin portion 140.

According to exemplary embodiments, the protrusions 130 may extend in a direction Y that is perpendicular to a winding direction X and parallel to the coated region 110. The protrusions 130 extending in the direction Y may serve as tabs that come into contact with the current collector plate to transfer electrons. Accordingly, a tab-less battery may be implemented.

According to exemplary embodiments, the protrusions 130 may include the protrusions 130a and 130b having different polarities.

For example, the protrusions 130 may include the protrusions 130a of the cathode collector and protrusions 130b of the anode collector.

The protrusions 130a of the cathode collector and the protrusions 130b of the anode collector may be separated by the separator. For example, the protrusions 130a of the cathode collector and the protrusions 130b of the anode collector may not overlap each other in the thickness direction.

According to exemplary embodiments, the margin portion 140 may represent the remainder of the uncoated region excluding the protrusions 130.

For example, the margin portion 140 may be formed between the coated region 110 and the protrusions 130 of the uncoated region.

According to exemplary embodiments, the margin portion 140 may be disposed between the coated region 110 and the protrusions 130 and may extend in the winding direction X.

According to exemplary embodiments, the margin portion 140 may include margin portions 140a and 140b having different polarities.

For example, the margin portion 140 may include a margin portion 140a of the cathode current collector and a margin portion 140b of the anode current collector.

The margin portion 140a of the cathode collector and the margin portion 140b of the anode collector may be separated by the separator. For example, the margin portion 140a of the cathode collector and the margin portion 140b of the anode collector may not overlap each other in the thickness direction.

The tab region B2, the first margin region B1, and the second margin region B3 may be distinguished from each other by the protrusions 130. For example, the tab region B2 may include the protrusions 130, while the first margin region B1 and the second margin region B3 may not include the protrusions 130.

According to exemplary embodiments, the tab region B2 may include the protrusions 130. For example, the tab region B2 may include both the protrusions 130 and the margin portion 140.

According to exemplary embodiments, the first margin region B1 and the second margin region B3 may each include the margin portion 140. In one embodiment, the first margin region B1 and the second margin region B3 may each be substantially composed of the margin portion 140.

According to exemplary embodiments, the electrode and/or electrode assembly 100 may include a winding start part I₁ and a winding end part I₂, which are spaced apart from each other in the winding direction X. For example, the winding start part I₁ may correspond to a winding center of the electrode and/or electrode assembly 100.

According to exemplary embodiments, the first margin region B1 may be located between the tab region B2 and the winding start part I₁. The first margin region B1 may include a first margin portion 141, which is disposed between the tab region B2 and the winding start part I₁.

According to exemplary embodiments, the second margin region B3 may be located between the tab region B2 and the winding end part 12. The second margin region B3 may include a second margin portion 142, which is disposed between the tab region B2 and the winding end part I₂.

Each of the lengths of the first margin region B1, the tab region B2 and the second margin region B3 in the winding direction X may be adjusted within a predetermined range in consideration of electrolyte impregnation properties and resistance properties. In addition, the ratio among the lengths of the first margin region B1, the tab region B2 and the second margin region B3 in the winding direction X may also be adjusted within a predetermined range in consideration of electrolyte impregnation properties and resistance properties.

As used herein, the term “ratio of B to A” may represent “the percentage (%) of B relative to A.”

The lengths of the first margin region B1, the tab region B2 and the second margin region B3 may be the same as those of the margin portions included in each region. For example, the length of the first margin region B1 may be the same as that of the fast margin portion 141, and the length of the second margin region B3 may be the same as that of the second margin portion 142. For example, the length of the tab region B2 may be the same as that of the margin portion included in the tab region.

According to exemplary embodiments, a length ratio of the first margin region B1 to the total length of the electrode assembly 100 in the winding direction X may be 11% or more.

In some embodiments, the length ratio of the first margin region B1 to the total length of the electrode assembly 100 in the winding direction X may be 11.2% or more, 11.4% or more, 11.5% or more, 11.6% or more, 11.8% or more, 12.0% or more, 12.1% or more, 12.2% or more, 12.3% or more, 12.4% or more, or 12.5% or more.

According to exemplary embodiments, the length ratio of the first margin region B1 to the total length of the electrode assembly 100 in the winding direction X may be 17% or less.

In some embodiments, the length ratio of the first margin region B1 to the total length of the electrode assembly 100 in the winding direction X may be 16.8% or less, 16.6% or less, 16.5% or less, 16.4% or less, 16.2% or less, 16.0% or less, 15.8% or less, 15.6% or less, 15.5% or less, 15.4% or less, 15.3% or less, 15.2% or less, 15.1% or less, or 15.0% or less.

For example, the length ratio of the first margin region B1 to the total length of the electrode assembly 100 in the winding direction X may be 11% to 17%, 11.2% to 16.8%, 11.5% to 16.5%, 11.8% to 16.2%, 12.0% to 16.0%, 12.0% to 15.5%, 12.1% to 15.3%, or 12.2% to 15.0%.

Within the above range, the winding stability of the secondary battery may be improved, and the electrolyte impregnation properties may be enhanced. For example, the first margin region B1 may maintain a compact state at the winding center to improve mechanical stability. In addition, the electrolyte may be sufficiently impregnated from the center of the cylinder through portions where the protrusions 130 are not formed.

According to exemplary embodiments, a length ratio of the second margin region B3 to the total length of the electrode assembly 100 in the winding direction X may be 11% or more.

In some embodiments, the length ratio of the second margin region B3 to the total length of the electrode assembly 100 in the winding direction X may be 12% or more, 12.1% or more, 12.2% or more, or 12.3% or more.

According to exemplary embodiments, the length ratio of the second margin region B3 to the total length of the electrode assembly 100 in the winding direction X may be 20% or less.

In some embodiments, the length ratio of the second margin region B3 to the total length of the electrode assembly 100 in the winding direction X may be 19.8% or less, 19.0% or less, 18.0% or less, or 17.0% or less.

For example, the length ratio of the second margin region B3 to the total length of the electrode assembly 100 in the winding direction X may be 11% to 20%, 12% to 19%, 12.2% to 18%, or 12.2% to 17%.

Within the above range, winding stability and the electrolyte impregnation properties may be improved in conjunction with the first margin region B1. For example, the protrusions 130 of the tab region B2 may be protected from external impacts applied to the cylindrical cell. In addition, since the electrolyte may be sufficiently injected, the non-impregnated region may be reduced.

In some embodiments, the first margin region B1 may have a length of 500 mm or more, 510 mm or more, 520 mm or more, 530 mm or more, 540 mm or more, or 550 mm or more.

In some embodiments, the first margin region B1 may have a length of 700 mm or less, 695 mm or less, 690 mm or less, 685 mm or less, or 680 mm or less.

For example, the first margin region B1 may have a length of 500 mm to 700 mm, 520 mm to 695 mm, 530 mm to 690 mm, or 550 mm to 680 mm.

Within the above range, the winding compactness of the first margin region B1 may be improved.

In some embodiments, the second margin region B3 may have a length of 500 mm or more, 510 mm or more, 520 mm or more, 530 mm or more, 540 mm or more, or 550 mm or more.

In some embodiments, the second margin region B3 may have a length of 1,200 mm or less, 1,150 mm or less, 1,120 mm or less, 1,100 mm or less, 1,050 mm or less, or 1,000 mm or less.

For example, the second margin region B3 may have a length of 500 mm to 1,200 mm, 510 mm to 1,150 mm, 520 mm to 1,150 mm, 530 mm to 1,120 mm, or 550 mm to 1,120 mm.

Within the above range, the stability of the tab region B2 may be improved.

In some embodiments, the total length of the electrode assembly 100 in the winding direction X may be 4,000 mm or more, 4,050 mm or more, 4,070 mm or more, 4,080 mm or more, 4,090 mm or more, or 4,100 mm or more.

In some embodiments, the total length of the electrode assembly 100 in the winding direction X may be 6,000 mm or less, 5,950 mm or less, 5,920 mm or less, 5,900 mm or less, 5,850 mm or less, 5,800 mm or less, or 5,750 mm or less.

For example, the total length of the electrode assembly 100 in the winding direction X may be 4,000 mm to 6,000 mm, 4,050 mm to 5,950 mm, 4,080 mm to 5,850 mm, or 4,100 mm to 5,750 mm.

Within the above range, the contact area of the protrusions 130 of the tab region B2 during winding of the electrode assembly 100 may be improved.

The length of each region B1, B2 and B3 may be determined in consideration of the thickness of the electrode.

According to exemplary embodiments, the electrode assembly may have an L value of 80 to 120, 82 to 115, or 85 to 110, defined by Equation 1 below.

$$L = [ {L}_{B 1} / ( {L}_{B 2} \times D ) ] \times 100 \qquad [ Equation 1 ]$$

In Equation 1, L_{B1} is the length in millimeter (mm) of the first margin region B1, LB2 is the length in mm of the electrode assembly (B1+B2+B3), and D is the thickness in mm of the electrode.

In an electrode assembly having an L value satisfying Equation 1, the positions of the protrusions 130 in a wound state may be controlled, and thereby improving the stability and electrical properties of the secondary battery.

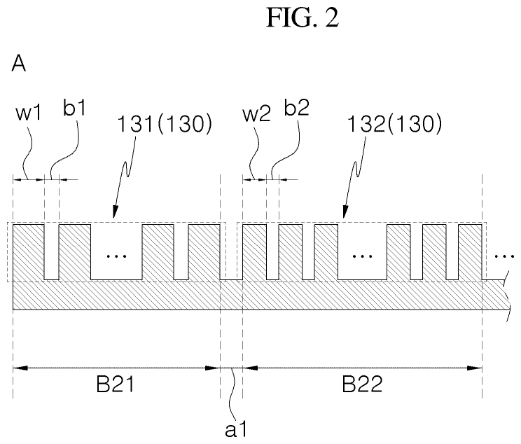

FIG. 2 is a schematic enlarged view illustrating the tab region of the electrode assembly according to exemplary embodiments. For example, FIG. 2 is a schematic enlarged view of region A shown in FIG. 1.

Referring to FIG. 2, the tab region B2 may include a first tab region B21 and a second tab region B22, which are adjacent to each other. A gap may be formed between the first tab region B21 and the second tab region B22. The first tab region B21 and the second tab region B22 may each include the protrusions 130.

According to exemplary embodiments, the widths of the protrusions 130 (referred to as first protrusions 131) of the first tab region B21 and the protrusions 130 (referred to as second protrusions 132) of the second tab region B22 may be different.

According to exemplary embodiments, a width w1 of each first protrusion 131 may be greater than the width w2 of each second protrusion 132 in the second tab region B22. For example, the width w1 of each of the first protrusions 131 may be greater than the width w2 of each of the second protrusions 132.

According to exemplary embodiments, the first tab region B21 may be disposed closer to the winding start part I₁ than the second tab region B22.

Since the first tab region B21, in which each of the protrusions has a greater width, is located closer to the winding start part I₁, the contact area between the protrusions and the electrode plate at the winding center of the cylindrical cell may be improved. Accordingly, the resistance properties of the secondary battery may be improved.

For example, when the first tab region B21, in which each of the protrusions has a greater width, is adjacent to the winding end part I₂, the effective contact area between the protrusions and the electrode plate may be reduced, thereby increasing the resistance of the secondary battery.

According to exemplary embodiments, the first tab region B21 and the second tab region B22 may be alternately and repeatedly arranged along the winding direction X.

For example, a tab region including protrusions having the same width as the first protrusions 131 may be formed between the second tab region B22 and the winding end part I₂. For instance, the first tab region B21 and the second tab region B22 may be arranged repeatedly two or more times along the winding direction X.

The widths of the respective protrusions included in a single tab region may be substantially the same as one another. For example, the widths w1 of each of the first protrusions 131 may be maintained within ±1.5% of the average width of the widths of the protrusions. The widths of the respective protrusions included in a single tab region may be consistently applied to the first to fifth tab regions B21 to B25 described below.

According to exemplary embodiments, a ratio of the width w2 of each of the second protrusions 132 to the width w1 of each of the first protrusions 131 may be 50% or more.

In some embodiments, the ratio of the width w2 of each of the second protrusions 132 to the width w1 of each of the first protrusions 131 may be 50% or more, 52% or more, 53% or more, 54% or more, or 55% or more.

According to exemplary embodiments, the ratio of the width w2 of each of the second protrusions 132 to the width w1 of each of the first protrusions 131 may be 95% or less.

In some embodiments, the ratio of the width w2 of each of the second protrusions 132 to the width w1 of each of the first protrusions 131 may be 93% or less, 91% or less, 90% or less, or 89% or less.

For example, the ratio of the width w2 of each of the second protrusions 132 to the width w1 of each of the first protrusions 131 in the first tab region B21 may be 50% to 95%, 52% to 93%, 53% to 91%, 54% to 90%, or 55% to 89%.

Within the above range, the structure of the protrusions formed by the winding of the tab region may be controlled. As a result, the resistance properties of the secondary battery may be improved.

The width b1 of the gap between the first protrusions 131 and the width b2 of the gap between the second protrusions 132 may be controlled. Accordingly, the gap between the protrusions can be secured in the wound state, and the contact area between the protrusions and the electrode plate may be substantially increased, thereby reducing the resistance of the secondary battery.

According to exemplary embodiments, the width b1 of the gap between the first protrusions 131 may be 0.05 mm to 0.3 mm.

According to exemplary embodiments, the width b2 of the gap between the second protrusions 132 may be 0.07 mm to 0.4 mm.

Within the above range, a sufficient space for electrolyte penetration may be secured without degradation of the winding stability, thereby improving both stability and electrolyte impregnation properties.

A width a1 of the gap between the first tab region B21 and the second tab region B22 may also be controlled together.

The gap may represent the distance between the last protrusion in the winding direction X of the first tab region B21 and the first protrusion in the winding direction X of the second tab region B22.

According to exemplary embodiments, the width a1 of the gap between the first tab region B21 and the second tab region B22 may be 0.06 mm to 0.5 mm. Within the above range, the overlap between the protrusions during winding may be reduced.

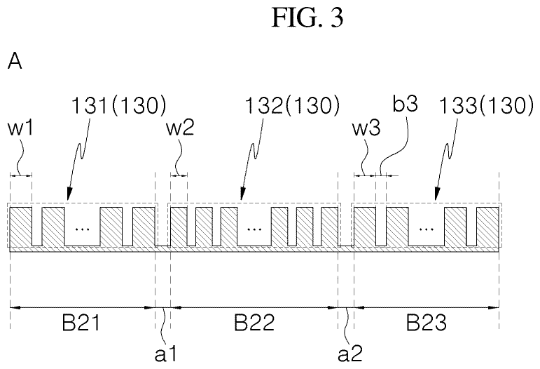

FIGS. 3 to 5 are schematic enlarged views illustrating the tab regions of the electrode assembly according to some embodiments. For example, FIGS. 3 to 5 are schematic enlarged views illustrating region A shown in FIG. 1.

Referring to FIG. 3, the tab region B2 may include the first tab region B21 and the second tab region B22 according to the above-described embodiments. The tab region B2 may further include a third tab region B23 which is disposed adjacent to the second tab region B22. A gap may be formed between the second tab region B22 and the third tab region B23. The third tab region B23 may include the protrusions 130 (referred to as third protrusions 133).

According to exemplary embodiments, the first tab region B21, the second tab region B22 and the third tab region B23 may be arranged sequentially from the winding start part I₁. For example, the second tab region B22 may be disposed between the first tab region B21 and the third tab region B23.

According to exemplary embodiments, a width w3 of each of the third protrusions 133 may be greater than the width w2 of each of the second protrusions 132.

According to exemplary embodiments, a ratio of the width w2 of each of the second protrusions 132 to the width w3 of each of the third protrusions 133 may be 50% or more.

In some embodiments, the ratio of the width w2 of each of the second protrusions 132 to the width w3 of each of the third protrusions 133 may be 50% or more, 52% or more, 53% or more, 54% or more, or 55% or more.

According to exemplary embodiments, the ratio of the width w2 of each of the second protrusions 132 to the width w3 of each of the third protrusions 133 may be 95% or less.

In some embodiments, the ratio of the width w2 of each of the second protrusions 132 to the width w3 of each of the third protrusions 133 may be 93% or less, 91% or less, 90% or less, or 89% or less.

For example, the ratio of the width w2 of each of the second protrusions 132 to the width w3 of each of the third protrusions 133 may be 50% to 95%, 52% to 93%, 53% to 91%, 54% to 90%, or 55% to 89%.

Within the above range, the structure of the protrusions formed by the winding of the tab region may be controlled, thereby increasing the contact area of the protrusions. As a result, the resistance properties of the secondary battery may be enhanced.

In some embodiments, the width w3 of each of the third protrusions 133 may be greater than the width w1 of each of the first protrusions 131. Since the diameter of a cylinder formed by the winding of the third tab region B23 may be greater than that of a cylinder formed by the winding of the first tab region B21, protrusions having a greater width may be required in the third tab region B23.

According to exemplary embodiments, a width b3 of the gap between the third protrusions 133 may be 0.08 mm to 0.6 mm.

Within the above range, a sufficient space for electrolyte penetration may be secured, thereby enhancing the electrolyte impregnation properties.

According to exemplary embodiments, a width a2 of the gap between the third tab region B23 and the second tab region B22 may be 0.1 mm to 0.6 mm. Within the above range, the overlap between the protrusions during winding may be reduced.

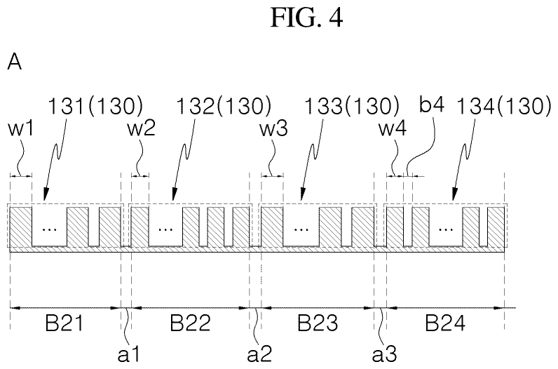

Referring to FIG. 4, the tab region B2 may include the first tab region B21, the second tab region B22 and the third tab region B23 according to the above-described embodiments. The tab region B2 may further include a fourth tab region B24 disposed adjacent to the third tab region B23. A gap may be formed between the third tab region B23 and the fourth tab region B24. The fourth tab region B24 may include the protrusions 130 (referred to as fourth protrusions 134).

According to exemplary embodiments, the first tab region B21, the second tab region B22, the third tab region B23 and the fourth tab region B24 may be arranged sequentially from the winding start part I₁. For example, the third tab region B23 may be disposed between the second tab region B22 and the fourth tab region B24.

According to exemplary embodiments, a width w4 of each of the fourth protrusions 134 may be smaller than the width w3 of each of the third protrusions 133.

According to exemplary embodiments, a ratio of the width w4 of each of the fourth protrusions 134 to the width w3 of each of the third protrusions 133 may be 50% or more.

In some embodiments, the ratio of the width w4 of each of the fourth protrusions 134 to the width w3 of each of the third protrusions 133 may be 50% or more, 52% or more, 53% or more, 54% or more, or 55% or more.

According to exemplary embodiments, the ratio of the width w4 of each of the fourth protrusions 134 to the width w3 of each of the third protrusions 133 may be 95% or less.

In some embodiments, the ratio of the width w4 of each of the fourth protrusions 134 to the width w3 of each of the third protrusions 133 may be 93% or less, 91% or less, 90% or less, or 89% or less.

For example, the ratio of the width w4 of each of the fourth protrusions 134 to the width w3 of each of the third protrusions 133 may be 50% to 95%, 52% to 93%, 53% to 91%, 54% to 90%, or 55% to 89%.

Within the above range, a sufficient space for electrolyte penetration may be formed between the protrusions, thereby reducing the unimpregnated region.

According to exemplary embodiments, a width b4 of the gap between the fourth protrusions 134 may be 0.1 mm to 0.8 mm.

Within the above range, a sufficient space may be formed between the protusions, thereby increasing the space for electrolyte penetration and further improving the electrolyte impregnation properties.

According to exemplary embodiments, a width a3 of the gap between the fourth tab region B24 and the third tab region B23 may be 0.1 mm to 0.7 mm. Within the above range, the overlap between the protrusions during winding may be reduced.

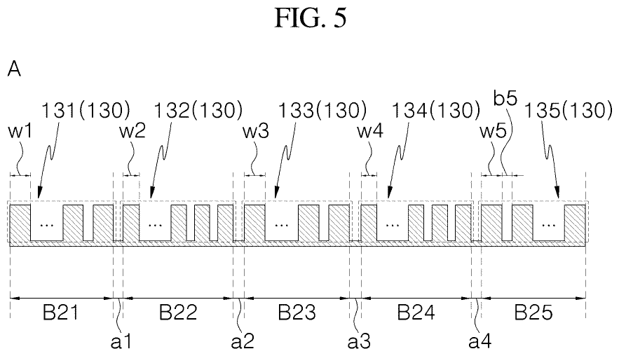

Referring to FIG. 5, the tab region B2 may include the first tab region B21, the second tab region B22, the third tab region B23 and the fourth tab region B24 according to the above-described embodiments. The tab region B2 may further include a fifth tab region B25 disposed adjacent to the fourth tab region B24. A gap may be formed between the fourth tab region B24 and the fifth tab region B25. The fifth tab region B25 may include the protrusions 130 (referred to as fifth protrusions 135).

According to exemplary embodiments, the first tab region B21, the second tab region B22, the third tab region B23, the fourth tab region B24 and the fifth tab region B25 may be arranged sequentially from the winding start part I₁. For example, the fourth tab region B24 may be disposed between the third tab region B23 and the fifth tab region B25.

According to exemplary embodiments, a width w5 of each of the fifth protrusions 135 may be greater than the width w4 of each of the fourth protrusions 134.

According to exemplary embodiments, a ratio of the width w4 of each of the fourth protrusions 134 to the width w5 of each of the fifth protrusions 135 may be 50% or more.

In some embodiments, the ratio of the width w4 of each of the fourth protrusions 134 to the width w5 of each of the fifth protrusions 135 may be 50% or more, 52% or more, 53% or more, 54% or more, or 55% or more.

According to exemplary embodiments, the ratio of the width w4 of each of the fourth protrusions 134 to the width w5 of each of the fifth protrusions 135 may be 95% or less.

In some embodiments, the ratio of the width w4 of each of the fourth protrusions 134 to the width w5 of each of the fifth protrusions 135 may be 93% or less, 91% or less, 90% or less, or 89% or less.

For example, the ratio of the width w4 of each of the fourth protrusions 134 to the width w5 of each of the fifth protrusions 135 may be 50% to 95%, 52% to 93%, 53% to 91%, 54% to 90%, or 55% to 89%.

Within the above range, the contact area of the protrusions adjacent to the outer periphery may be increased. Accordingly, even if the size of the electrode increases, an increase in the resistance of the electrode may be suppressed.

In some embodiments, a width w5 of each of the fifth protrusions 135 may be greater than the width w1 of each of the first protrusions 131 and the width w3 of each of the third protrusions 133. The diameter of a cylinder formed by winding the fifth tab region B25 adjacent to the winding end part I₂ may be greater than that of a cylinder formed by the winding of the first tab region B21 and the third tab region B23, and thus the contact area may be increased by the protrusions having a greater width. In addition, as the width of the protrusions increase, the mechanical stability also increases, thereby improving the impact resistance.

According to exemplary embodiments, a width b5 of the gap between the fifth protrusions 135 may be 0.15 mm to 1.0 mm.

Within the above range, a sufficient space may be formed between the protrusions, thereby improving the electrolyte impregnation properties.

According to exemplary embodiments, a width a4 of the gap between the fifth tab region B25 and the fourth tab region B24 may be 0.15 mm to 1.0 mm. Within the above range, the overlap between the protrusions during winding may be reduced.

In some embodiments, the height of each of the protrusions in the first to fifth tab regions B21 to B25 may be adjusted in consideration of the length of the electrode assembly 100. The height may represent the length in the above-described width direction.

In some embodiments, a ratio of the height of each of the protrusions in the tab region B2 to the length of the electrode assembly may be 0.05% or more, 0.06% or more, 0.07% or more, 0.08% or more, or 0.09% or more.

In some embodiments, the ratio of the height of each of the protrusions in the tab region B2 to the length of the electrode assembly may be 0.20% or less, 0.18% or less, 0.17% or less, 0.16% or less, 0.15% or less, or 0.14% or less.

For example, the ratio of the height of each of the protrusions in the tab region B2 to the length of the electrode assembly may be 0.05% to 0.20%, 0.06% to 0.18%, 0.07% to 0.17%, 0.08% to 0.15%, or 0.09% to 0.14%.

Within the above range, contact between the cathode and the anode may be prevented. In addition, the contact area of the protrusions per unit space may be increased, thereby improving the energy density of the secondary battery.

In some embodiments, the heights of the protrusions in each tab region of the first to fifth tab regions B21 to B25 may be substantially the same. For example, the heights of the first protrusions 131 may be substantially the same as the heights of the second protrusions 132, the heights of the third protrusions 133, the heights of the fourth protrusions 134, and/or the heights of the fifth protrusions 135. For example, the heights of the protrusions in the first to fifth tab regions B21 to B25 may be maintained within ±1.5% of an average value of their respective heights.

Accordingly, the bonding of the respective protrusions may be facilitated without degradation of the electrical properties of the secondary battery.

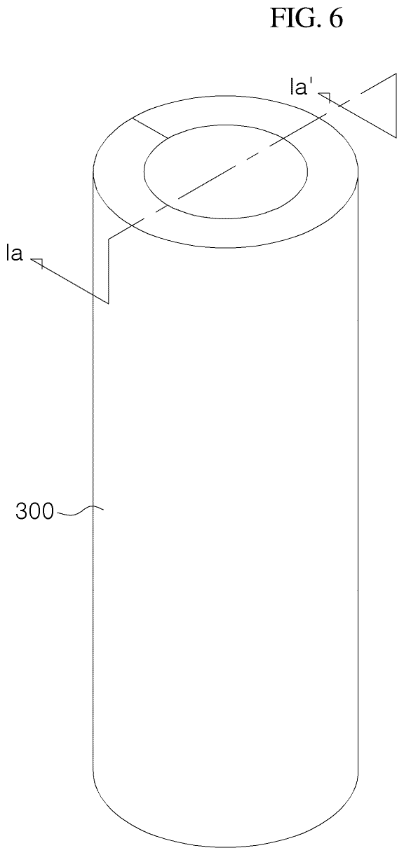

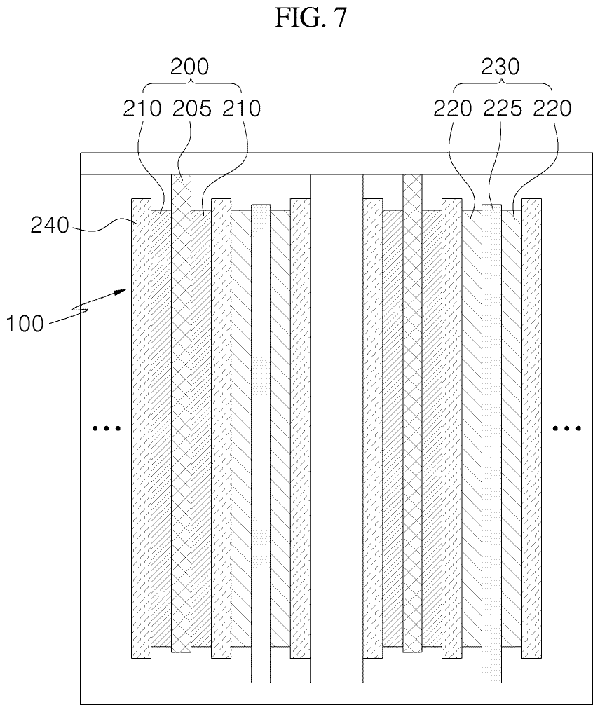

FIGS. 6 and 7 are schematic perspective and cross-sectional views illustrating a secondary battery including the electrode assembly according to exemplary embodiments. Specifically, FIG. 7 is a cross-sectional view of a secondary battery according to exemplary embodiments of the present disclosure taken along line Ia-Ia′ in FIG. 6.

Referring to FIGS. 6 and 7, the electrode assembly may be accommodated in a case 300. The protrusions of the electrode current collectors (also referred to as cathode and anode current collectors) 205 and 225 of the electrode assembly may be in contact with the electrode plate.

For example, the electrode assembly 100 may be bent in a winding direction surrounding an imaginary winding center. For example, the first margin region B1 may be closer to the winding center than the tab region B2, and the tab region B2 may be closer to the winding center than the second margin region B3.

For example, the winding center may represent a winding core of the secondary battery. For example, the winding core may have a cylindrical shape. For example, the winding core may have a diameter of 3 mm to 8 mm.

For example, the cathode 200 and the anode 230 according to the above-described embodiments may be repeatedly stacked starting from the winding core, and a separator 240 may be disposed between the cathode 200 and the anode 230.

The cathode 200 includes the cathode current collector 205 and the cathode active material layer 210 formed on at least one surface of the cathode current collector 205. The anode 230 includes the anode current collector 225 and the anode active material layer 220 formed on at least one surface of the anode current collector 225.

In some embodiments, the secondary battery may include a jelly roll shape in which the electrode assembly 100 is repeatedly wound around the winding core.

In one embodiment, the electrode assembly 100 may be placed on a core pin, repeatedly wound around the core pin, and then the core pin may be removed to form the jelly roll shape.

For example, the winding core may represent a void formed by removing the core pin. For example, the size and shape of the winding core may be substantially the same as the size and shape of the core pin. For example, the diameter of the winding core may be substantially the same as the diameter of the core pin.

For example, the core pin may include a metal and/or an alloy.

For example, the cathode 200, the anode 230, and the separator 240 may be stacked and wound such that the separator 240 is disposed between each pair of the cathode 200 and the anode 230.

For example, in the cross section of the secondary battery, according to the winding process, a sequentially stacked structure of the anode 230, the separator 240, the cathode 200, the separator 240, the anode 230, the separator 240 and the cathode 200 may be repeatedly formed on the winding core.

In some embodiments, the electrode assembly 100 may be accommodated in the case 300.

For example, the electrode assembly 100 may be accommodated in the case 300 together with an electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF₂⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethylpropionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THE), 2-methyltetrahydrofuran, ethyl alcohol, isopropyl alcohol, dimethyl sulfoxide, acetonitrile, diethoxyethane, sulfolane, gamma-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithiumdifluoro bis(oxalato)phosphate, lithiumdifluoro phosphate, etc.

The borate compound may include lithium bis(oxalate) borate, etc.

In some embodiments, a solid electrolyte may also be used in place of the above-described non-aqueous electrolyte. In this case, the lithium secondary battery may be manufactured in the form of an all-solid-state battery. In addition, a solid electrolyte layer may also be disposed between the cathode 200 and the anode 230 in place of the above-described separator 240.

The solid electrolyte may include a sulfide-based electrolyte. As a non-limiting example, the sulfide based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₙSₙ (m and n are positive numbers, Z is Ge, Zn or Ga), Li₂S—GeS₂, Li₂S—SiS₂—Li₃PO₄, Li₂S—SiS₂—LiₚMO_{q} (p and q are positive numbers, M is P, Si, Ge, B, Al, Ga or In), Li₇₋ₓPS₆₋ₓClₓ (0≤x≤2), Li₇₋ₓPS₆₋ₓBrₓ (0≤x≤2), Li₇₋ₓPS₆₋ₓT (0≤x≤2), etc. These may be used alone or in combination of two or more thereof.

In one embodiment, the solid electrolyte may also include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

According to exemplary embodiments, the case 300 may have a cylindrical shape.

According to exemplary embodiments, the secondary battery may be provided as a cylindrical secondary battery.

According to exemplary embodiments, a current collector plate may be included inside the case 300. The protrusions of the electrode assembly 100 may be in contact with the current collector plate, and thus no additional electrode leads or electrode tabs may be required.

According to exemplary embodiments, the secondary battery may be provided as a tab-less secondary battery.

Hereinafter, embodiments of the present disclosure will be further described with reference to specific experimental examples. However, the following examples and comparative examples included in the experimental examples are only given for illustrating the present disclosure and those skilled in the aft will obviously understand that various alterations and modifications are possible within the scope and spirit of the present disclosure. Such alterations and modifications are duly included in the appended claims.

### Examples and Comparative Examples

### (1) Fabrication of Electrode Assembly

### 1) Preparation of Cathode

NiSO₄, CoSO₄ and MnSO₄ were added and mixed in a molar ratio of 0.8:0.1:0.1 in distilled water from which dissolved oxygen had been removed by bubbling N₂ through it for 24 hours to prepare a mixed solution. The mixed solution was introduced into a reactor at 55° C., and a co-precipitation reaction was performed for 36 hours using NaOH and NH₃·H₂O as a precipitant and a chelating agent, to obtain Ni_{0.8}Co_{0.1}Mn_{0.1}(OH)₂ as a transition metal precursor. The transition metal precursor was dried at 80° C. for 12 hours, and then further dried at 110° C. for additional 12 hours.

Lithium hydroxide and the transition metal precursor were added to a dry high-speed mixer in a ratio of 1.05:1 and uniformly mixed for 5 minutes. The mixture was placed in a calcination furnace under an oxygen atmosphere, heated to 950° C. at a heating rate of 2°Groin, and maintained at 950° C. for 12 hours. Oxygen was continuously supplied at a flow rate of 10 mL/min during the heating and calcination. After completion of the calcination, the calcined product was naturally cooled to room temperature, and then pulverized and classified to obtain a cathode active material having a composition of LiNi_{0.8}Co_{0.1}Mn_{0.1}O₂ (median particle diameter (D50): 10 μm).

A cathode slurry was prepared by mixing the cathode active material, carbon black as a conductive material, and PVDF as a binder in a mass ratio of 95:3:2. The cathode slurry was coated on both surfaces of an aluminum current collector, and then dried and roll-pressed to prepare a cathode.

### 2) Preparation of Anode

An anode slurry, which included 93 wt % of natural graphite as an anode active material, 5 wt % of flake type graphite (KS6) as a conductive material, 1 wt % of styrene-butadiene rubber (SBR) as a binder, and 1 wt % of catboxymethyl cellulose (CMC) as a thickener, was prepared. The anode slurry was coated on both surfaces of a copper current collector, and then dried and roll-pressed to prepare an

### 3) Fabrication of Electrode Assembly

The cathode, the anode, and a separator (polyethylene, thickness: 25 μm) were repeatedly stacked to form an electrode assembly. In the electrode assembly, portions where the cathode slurry and the anode slurry were not coated was cut and/or segmented to form an uncoated region including a plurality of protrusions having widths as shown in Tables 1 and 2 below, and margin portions and tab regions having lengths as shown in Table 3. In Table 3, the first length ratio (%) represents the percentage (%) of the length of the first margin portion 141 (the first margin region B1) relative to the total length, and the second length ratio (%) represents the percentage (%) of the length of the second margin portion 142 (the second margin region B3) relative to the total length.

The electrode assemblies of Examples 1 to 6, and Comparative Examples 1 to 6 include four protrusions, respectively. The electrode assemblies of Examples 7 to 10 and Comparative Examples 7 and 8 include five protrusions, respectively. The electrode assemblies of Examples 11 to 17 include four protrusions, respectively. The widths, heights, and numbers of the protrusions of Examples 11 to 17 were controlled to be same as those of Example 1.

### (2) Manufacturing of Secondary Battery

The electrode assembly was repeatedly wound around a core pin, and then the core pin was removed to form a winding structure. The diameter of the winding core of the winding structure was the same as that of the core pin.

The winding structure was placed in a cylindrical case, and an electrolyte was injected. Then, a cap was mounted and clamped. The electrolyte used herein was prepared by adding 2.0 vol % of fluoroethylene carbonate (FEC) to a 1M LiPF₆ solution prepared using a mixed solvent of EC/EMC (3:7; volume ratio) based on the total volume of the electrolyte. After clamping, the structure was impregnated for 3 to 24 hours, and then three charge/discharge cycles were performed at 0.1C (charging conditions: CC-CV0.1C0.01V0.01C CUT-OFF, discharging conditions: CC0.1C 1.5V CUT-OFF).

TABLE 1

| | | Width of | Width of | Width of | Width of |
|---|---|---|---|---|---|
| | | first | second | third | fourth |
| | Height of | protrusion | protrusion | protrusion | protrusion |
| Classification | protrusion(mm) | (mm) | (mm) | (mm) | (mm) |
| Example 1 | 6 | 4.5 | 2.5 | 4.5 | 2.5 |
| Example 2 | 6 | 4.0 | 2.5 | 4.0 | 2.5 |
| Example 3 | 6 | 3.5 | 2.5 | 3.5 | 2.5 |
| Example 4 | 6 | 3.0 | 2.5 | 3.0 | 2.5 |
| Example 5 | 6 | 4.5 | 2.5 | 3.5 | 2.5 |
| Example 6 | 6 | 4.0 | 2.5 | 3.5 | 2.5 |
| Comparative | 6 | 2.5 | 2.5 | 2.5 | 2.5 |
| Example 1 | | | | | |
| Comparative | 6 | 2.5 | 4.5 | 2.5 | 4.5 |
| Example 2 | | | | | |
| Comparative | 6 | 2.5 | 4.0 | 2.5 | 4.0 |
| Example 3 | | | | | |
| Comparative | 6 | 2.5 | 3.5 | 2.5 | 3.5 |
| Example 4 | | | | | |
| Comparative | 6 | 2.5 | 3.0 | 2.5 | 3.0 |
| Example 5 | | | | | |
| Comparative | 6 | 2.5 | 3.0 | 3.5 | 4.5 |
| Example 6 | | | | | |

TABLE 2

| | | Width | Width | Width | Width | Width |
|---|---|---|---|---|---|---|
| | Height | of | of | of | of | of |
| | of | first | second | third | fourth | fifth |
| | protrusion | protrusion | protrusion | protrusion | protrusion | protrusion |
| Classification | (mm) | (mm) | (mm) | (mm) | (mm) | (mm) |
| Example 7 | 6 | 4.5 | 2.5 | 4.5 | 2.5 | 4.5 |
| Example 8 | 6 | 4.0 | 2.5 | 4.0 | 2.5 | 4.0 |
| Example 9 | 6 | 3.5 | 2.5 | 3.5 | 2.5 | 3.5 |
| Example 10 | 6 | 3.0 | 2.5 | 3.0 | 2.5 | 3.0 |
| Comparative | 6 | 2.5 | 2.5 | 2.5 | 2.5 | 2.5 |
| Example 7 | | | | | | |
| Comparative | 6 | 2.5 | 3.0 | 3.5 | 4.5 | 5.0 |
| Example 8 | | | | | | |

TABLE 3

| | Length | Length | Length | Total | | Length ratio (%) | |
|---|---|---|---|---|---|---|---|
| | (mm) of | (mm) of | (mm) of | length | Cathode | First | Second |
| | first | second | tab | (B1 + | thick- | length | length |
| | margin | margin | region | B2 + | ness | ratio | ratio |
| Classification | 141, B1 | 142, B3 | B2 | B3) (mm) | (mm) | (%) | (%) |
| Example 1 | 561 | 560 | 3086 | 4207 | 0.149 | 13.3 | 13.3 |
| Example 11 | 652 | 650 | 2905 | 4207 | 0.149 | 15.5 | 15.5 |
| Example 12 | 679 | 680 | 4171 | 5530 | 0.113 | 12.3 | 12.3 |
| Example 13 | 252 | 255 | 3700 | 4207 | 0.149 | 6.0 | 6.1 |
| Example 14 | 337 | 338 | 3532 | 4207 | 0.149 | 8.0 | 8.0 |
| Example 15 | 420 | 425 | 3362 | 4207 | 0.149 | 10.0 | 10.1 |
| Example 16 | 1106 | 530 | 3894 | 5530 | 0.113 | 20.0 | 9.6 |
| Example 17 | 670 | 1106 | 3754 | 5530 | 0.113 | 12.1 | 20.0 |

### Experimental Example

### (1) Evaluation of Electrolyte Impregnation Properties

After disassembling the secondary batteries according to the examples and comparative examples, the electrolyte impregnation was evaluated by measuring the size of the non-impregnated region as the length in a Y direction visually identified. The measurement results are shown in Table 4 below. The size was represented as a range between the minimum and maximum values if the size of the non-impregnated region differed depending on the position of the electrode assembly.

### (2) Measurement of Resistance of Secondary Battery

The secondary batteries were charged (under 0.3C CC/CV conditions, 4.2V 0.05C cut-off) at a temperature of 25° C., rested for 10 minutes, and then discharged (under 0.3C CC conditions) until SOC 50% was reached. After resting for 1 hour at SOC 50%, the batteries were discharged at 1C for 10 seconds and then further rested for additional 10 seconds. At this time, the discharge resistance (DC-IR) at SOC 50% was calculated by dividing the voltage difference between the voltage after resting at SOC 50% for 1 hour and the voltage after the end of the 1C discharge for 10 seconds by the 1C current value. The measurement results are shown in Table 4 below.

TABLE 4

| | Unimpregnated | Resistance |
|---|---|---|
| | region (mm) | (mΩ) |
| Example 1 | 0 | 1.08 |
| Example 2 | 0 | 1.06 |
| Example 3 | 0 | 1.04 |
| Example 4 | 0 | 1.03 |
| Example 5 | 0 | 1.05 |
| Example 6 | 0 | 1.03 |
| Example 7 | 0 | 1.09 |
| Example 8 | 0 | 1.05 |
| Example 9 | 0 | 1.03 |
| Example 10 | 0 | 1.03 |
| Example 11 | 0 | 1.08 |
| Example 12 | 0 | 1.05 |
| Example 13 | 7 | 1.23 |
| Example 14 | 4 | 1.20 |
| Example 15 | 0.5 to 1.0 | 1.16 |
| Example 16 | 0 | 1.37 |
| Example 17 | 0 | 1.13 |
| Comparative | 8 | 1.43 |
| Example 1 | | |
| Comparative | 0.5 to 1.5 | 1.22 |
| Example 2 | | |
| Comparative | 1.5 to 2.3 | 1.25 |
| Example 3 | | |
| Comparative | 2.0 to 2.5 | 1.29 |
| Example 4 | | |
| Comparative | 2.0 to 3.2 | 1.30 |
| Example 5 | | |
| Comparative | 0.3 to 1.5 | 1.25 |
| Example 6 | | |
| Comparative | 8 | 1.43 |
| Example 7 | | |
| Comparative | 0.4 to 1.2 | 1.26 |
| Example 8 | | |

Referring to Table 4, in the secondary batteries according to the examples, the non-impregnated region decreased and the resistance also decreased.

In the secondary batteries according to the comparative examples, the non-impregnated region increased and the resistance also increased.

In the secondary batteries according to Examples 13 to 15, where the length of the first margin portion was relatively short, the non-impregnated region observed, and the resistance increased relatively.

In Example 16, where the length of the first margin portion was relatively long, no non-impregnated region was observed, but the resistance increased

What is claimed is:

1. An electrode assembly comprising:
a separator; and
an electrode that is wound with the separator therebetween, and comprises an electrode current collector comprising a coated region and an uncoated region, and an active material layer formed on the coated region of the electrode current collector,
wherein the uncoated region comprises a tab region including protrusions that extend in a direction perpendicular to the winding direction of the electrode and parallel to the coated region,
wherein the tab region comprises a first tab region and a second tab region, which are adjacent to each other, and the protrusions comprise first protrusions included in the first tab region and second protrusions included in the second tab region, and
wherein the first tab region is disposed closer to a winding start part of the electrode assembly than the second tab region, and a width of each of the first protrusions is greater than that of each of the second protrusions.

2. The electrode assembly according to claim 1, wherein the first tab region and the second tab region are alternately repeated along the winding direction.

3. The electrode assembly according to claim 1, wherein a ratio of the width of each of the second protrusions to the width of each of the first protrusions is 50% to 95%.

4. The electrode assembly according to claim 1, wherein the uncoated region further comprises a third tab region including third protrusions having a width greater than that of each of the second protusions, and
the second tab region is disposed between the first tab region and the third tab region.

5. The electrode assembly according to claim 4, wherein a ratio of the width of each of the second protrusions to the width of each of the third protrusions is 50% to 95%.

6. The electrode assembly according to claim 4, wherein the uncoated region further comprises a fourth tab region including fourth protrusions having a width smaller than that of each of the third protrusions, and
the third tab region is disposed between the second tab region and the fourth tab region.

7. The electrode assembly according to claim 6, wherein a ratio of the width of each of the fourth protrusions to the width of each of the third protrusions is 50% to 95%.

8. The electrode assembly according to claim 6, wherein the uncoated region further comprises a fifth tab region including fifth protrusions having a width greater than that of each of the fourth protrusions, and
the fourth tab region is disposed between the third tab region and the fifth tab region.

9. The electrode assembly according to claim 8, wherein a ratio of the width of each of the fourth protrusions to the width of each of the fifth protrusions is 50% to 95%.

10. The electrode assembly according to claim 8, wherein the first tab region, the second tab region, the third tab region, the fourth tab region and the fifth tab region are arranged sequentially from the winding start part.

11. The electrode assembly according to claim 1, wherein the uncoated region is disposed between the coated region and the protrusions, and further comprises a margin portion extending in the winding direction.

12. The electrode assembly according to claim 11, wherein the margin portion comprises a first margin portion located at one end in the winding direction and a second margin portion located at the other end in the winding direction, and the tab region is disposed between the first margin portion and the second margin portion.

13. The electrode assembly according to claim 12, wherein a ratio of the length of the first margin portion to the total length of the electrode assembly in the winding direction is 11% to 17%.

14. The electrode assembly according to claim 12, wherein a ratio of the length of the first margin portion to the total length of the electrode assembly in the winding direction is 12% to 15.5%.

15. The electrode assembly according to claim 12, wherein a ratio of the length of the second margin portion to the total length of the electrode assembly in the winding direction is 11% to 20%.

16. The electrode assembly according to claim 12, wherein an L value, defined by Equation 1 below, is 80 to 120:
$$L = [ {L}_{B 1} / ( {L}_{B 2} \times D ) ] \times 100 \qquad [ Equation 1 ]$$
(in Equation 1, L_{B1} is the length in millimeter (mm) of the first margin portion, L_{B2} is the length in mm of the electrode assembly, and D is the thickness in mm of the electrode).

17. The electrode assembly according to claim 1, wherein a ratio of the height of the protrusions in the direction perpendicular to the winding direction and parallel to the coated region to the total length of the electrode assembly in the winding direction is 0.05% to 0.20%.

18. A secondary battery comprising:
the electrode assembly according to claim 1 wound around a winding core; and
a case configured to accommodate the electrode assembly.

19. The secondary battery according to claim 18, wherein the electrode assembly has a jelly roll structure in which it is repeatedly wound around the winding core.
